(19) United States
(12) Patent Application Publication
(10) Pub. No.: US 2024/0233449 A9
(43) Pub. Date: Jul. 11, 2024

(54) Dynamic Control of Operational Data Handling Settings in Mobile Robots

(71) Applicant: ZEBRA TECHNOLOGIES CORPORATION, Lincolnshire, IL (US)

(72) Inventors: Melonee Wise, San Jose, CA (US); Annelise Pruitt, San Jose, CA (US); Peter Arandorenko, Mississauga (CA); Benjamin Narin, Lincolnshire, IL (US); Aoran Jiao, Mississauga (CA); Achal Arvind, Santa Clara, CA (US)

(21) Appl. No.: 17/971,345

(22) Filed: Oct. 21, 2022

(51) Int. Cl. G07C 5/00; G07C 5/08

(52) U.S. Cl. CPC G07C 5/008; G07C 5/0808; G07C 5/085

(57) ABSTRACT

A method includes: maintaining data handling settings at a mobile robot; generating operational data at the mobile robot, the operational data defining a current state of the mobile robot; storing the operational data in a memory of the mobile robot; selecting, based on the data handling settings, a portion of the operational data; transmitting the selected portion of the operational data; in response to a determination that the operational data meets a condition, obtaining updated data handling settings; and selecting a subsequent portion of the operational data for transmission according to the updated data handling settings.

### BACKGROUND

Autonomous or semi-autonomous mobile robots can be deployed in facilities such as warehouses, manufacturing facilities, healthcare facilities, or the like, e.g., to transport items within the relevant facility. Tasks, such as instructions to travel to specified locations in the facility and retrieve certain items, can be assigned to mobile robots by a server. During execution of such tasks, each mobile robot may generate a variety of data relating to the operational status of the robot. Such data may be employed for diagnosis and/or remediation of operational issues at the robot or among a fleet of robots. However, collecting data from a fleet of robots may interfere with the assignment and execution of tasks within the fleet.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of an item-handing mobile robot deployed in a facility.

FIG. 2 is a diagram of certain components of a mobile robot of FIG. 1.

FIG. 3 is a flowchart illustrating a method of dynamically controlled operational data handling.

FIG. 4 is a diagram illustrating an example performance of block 305 of the method of FIG. 3.

FIG. 5 is a diagram illustrating an example performance of block 310 of the method of FIG. 3.

FIG. 6 is a diagram illustrating an example performance of blocks 310 to 335 of the method of FIG. 3.

FIG. 7 is a diagram illustrating an example performance of block 315 and 335 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: maintaining data handling settings at a mobile robot; generating operational data at the mobile robot, the operational data defining a current state of the mobile robot; storing the operational data in a memory of the mobile robot; selecting, based on the data handling settings, a portion of the operational data; transmitting the selected portion of the operational data; in response to a determination that the operational data meets a condition, obtaining updated data handling settings; and selecting a subsequent portion of the operational data for transmission according to the updated data handling settings.

Additional examples disclosed herein are directed to a computing device, including: a memory storing data handling settings; and a processor configured to: generate operational data defining a current state of a mobile robot; store the operational data in the memory; select, based on the data handling settings, a portion of the operational data; transmit the selected portion of the operational data; in response to a determination that the operational data meets a condition, obtain updated data handling settings; and select a subsequent portion of the operational data for transmission according to the updated data handling settings.

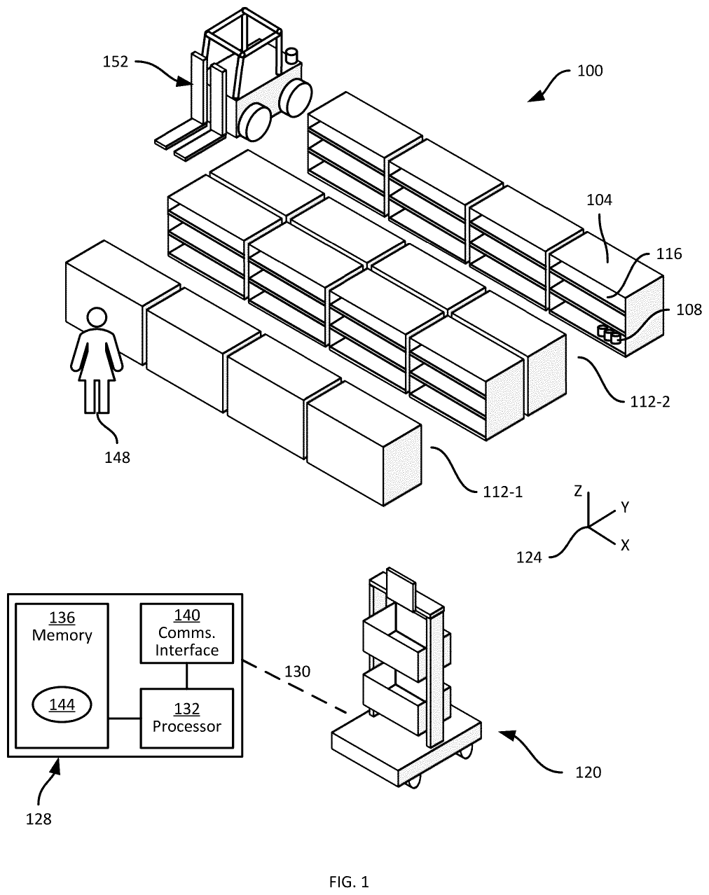

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as aisles 112, and generically referred to as an aisle 112; similar nomenclature is used herein for other components). As shown in FIG. 1, support structures 104 in the form of shelf modules include support surfaces 116 supporting the items 108. The support structures 104 can also include pegboards, bins, or the like, in other examples.

In other examples, the facility 100 can include fewer aisles 112 than shown, or more aisles 112 than shown in FIG. 1. The aisle 112, in the illustrated example, are formed by sets of eight support structures 104 (four on each side). The facility can also have a wide variety of other aisle layouts, however. As will be apparent, each aisle 112 is a space open at the ends, and bounded on either side by a support structure 104. The aisle 112 can be travelled by humans, vehicles, and the like. In still further examples, the facility 100 need not include aisles 112, and can instead include assembly lines, or the like.

The items 108 may be handled according to a wide variety of processes, depending on the nature of the facility 100. In some examples, the facility 100 is a shipping facility, distribution facility, or the like, and the items 108 can be placed on the support structures 104 for storage, and subsequently retrieved for shipping from the facility. Placement and/or retrieval of the items 108 to and/or from the support structures can be performed or assisted by a mobile robot 120. A greater number of robots 120 can be deployed in the facility 100 than the robot 120 shown in FIG. 1, for example based on the size and/or layout of the facility 100. Components of the robot 120 are discussed below in greater detail. In general, each robot 120 in the facility 100 is configured to transport items 108 within the facility 100.

The robot 120 can be configured to track its pose (e.g., location and orientation) within the facility 100, e.g., in a coordinate system 124 previously established in the facility 100. The robot 120 can navigate autonomously within the facility 100, e.g., travelling to locations assigned to the robot 120 to receive and/or deposit items 108. The items 108 can be deposited into or onto the robot 120, and removed from the robot 120, by human workers and/or mechanized equipment such as robotic arms and the like deployed in the facility 100. The locations to which each robot 120 navigates can be assigned to the robot 120 by a central server 128. That is, the server 128 is configured to assign tasks to the robot 120. Each task can include either or both of one or more locations to travel to, and one or more actions to perform at those locations. For example, the server 128 can assign a task to the robot 120 to travel to a location defined in the coordinate system 124, and to await the receipt of one or more items 108 at that location.

Tasks can be assigned to the robot 120 via the exchange of messages between the server 128 and the robots 120, e.g., over a link 130 defined by a suitable combination of local and wide-area networks. The server 128 can be deployed at the facility 100 and communicate with the robot 120 via one or more local networks, e.g., wireless local area networks (WLANs) deployed within the facility 100. In other examples, the server 128 is located remotely from the facility 100, and can communicate with the robot 120 via a combination of local and wide area networks. In some examples, the server 128 is configured to assign tasks to robots 120 at multiple facilities.

The server 128 includes a processor 132, such as one or more central processing units (CPU), graphics processing units (GPU), or dedicated hardware controllers such as application-specific integrated circuits (ASICs). The processor 132 is communicatively coupled with a non-transitory computer readable medium such as a memory 136, e.g., a suitable combination of volatile and non-volatile memory elements. The processor 132 is also coupled with a communications interface 140, such as a wireless transceiver enabling the robot 120 to communicate with other computing devices, such as the mobile robots 120. The memory 136 can store a plurality of computer-readable instructions executable by the processor 132, such as an application 144 whose execution by the processor 132 configures the processor 132 to manage certain aspects of the operations of the mobile robots 120, including instructing the robot 120 to adjust operational data handling settings under certain conditions, as discussed below.

To execute tasks assigned to the robot 120 by the server 128, the mobile robot 120 can be configured to capture and process sensor data, e.g., to detect obstacles in the facility 100 such as the support structures 104, a human worker 148, a forklift 152, or the like. The robot 120 can alter navigational behavior in response to detection of such obstacles, e.g., by altering the route taken by the robot 120, stopping travel along a route to allow passage of the worker 148 or forklift 152, or the like.

During execution of tasks by the robot 120, the robot 120 generates a variety of operational data. The operational data can include some or all of the above-mentioned sensor data, and data such as obstacle detections derived from the sensor data (e.g., a location of a detected obstacle in the coordinate system 124, and a type or class of the obstacle). The operational data can also include attributes such as a battery charge level of the robot 120, velocity measurements indicating the speed and direction of travel of the robot 120 at various points in time, and the like. The operational data can also include event data defining various events, such as navigational events (e.g., a mislocalization event indicating that the robot 120 generated a current pose with a confidence level below a predetermined threshold), connectivity events (e.g., an event indicating a temporary loss of wireless connectivity at the robot 120 to the WLAN mentioned earlier), and the like.

The robot 120 can be configured to store the operational data locally for a configurable period of time, as well as to transmit the operational data to the server 128 and/or to other mobile robots 120. The server 128 can, for example, employ the operational data received from the robot 120 (and any other robots 120 deployed in the facility 100) to generate performance metrics for the facility 100, diagnose errors in the robots 120, and the like. The volume of operational data generated by the robot 120, however, may be such that transmitting all the operational data substantially in real time (i.e., as the operational data is generated) may negatively impact the execution of tasks by the robot 120. For example, transmitting a significant volume of data may impose computational and/or communications loads on the robot 120 sufficient to interrupt the receipt of task instructions from the server 128, or the execution of such task instructions. Data transmissions by multiple robots 120 may also cause network congestion in the above-mentioned WLAN, and/or saturate a communications link from the facility 100 to the server 128, e.g., when the server 128 is remote from the facility 100. In some examples, network congestion caused by such data transmissions can also impede the establishment of connections from remote facilities to individual robots 120, e.g., by operating staff for monitoring and/or troubleshooting of the robots 120.

The server 128 and the robot 120 are therefore each configured to implement dynamic control of various data handling settings at the robot 120, to facilitate provision of the operational data from the robot 120 to the server 128 while mitigating performance impacts of such data transmission on the robot 120 or other robots 120 in the facility 100. The dynamic control of data handling settings is also implemented to mitigate delays in providing certain portions of the operational data to the server 128, even when providing all the operational data substantially in real time is not practical.

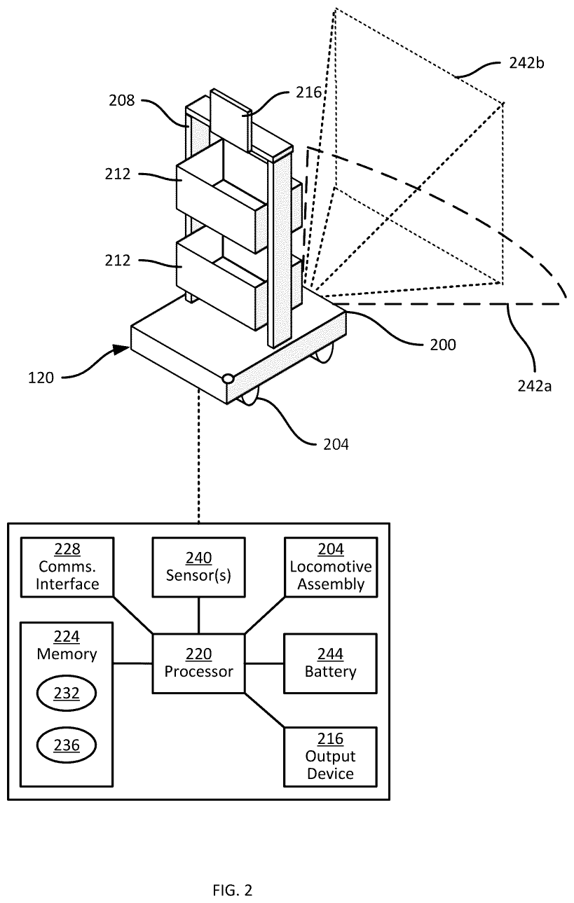

Before discussing the functionality implemented by the robot 120 in greater detail, certain components of the robot 120 are discussed with reference to FIG. 2. As shown in FIG. 2, the robot 120 includes a chassis 200 supporting various other components of the robot 120. In particular, the chassis 200 supports a locomotive assembly 204, such as one or more electric motors driving a set of wheels, tracks, or the like. The locomotive assembly 204 can include one or more sensors such as a wheel odometer, an inertial measurement unit (IMU), and the like.

The chassis 200 also supports receptacles, shelves, or the like, to support items 108 during transport. For example, the robot 120 can include a selectable combination of receptacles 212. In the illustrated example, the chassis 200 supports a rack 208, e.g., including rails or other structural features configured to support receptacles 212 at variable heights above the chassis 200. The receptacles 212 can therefore be installed and removed to and from the rack 208, enabling distinct combinations of receptacles 212 to be supported by the robot 120.

The robot 120 can also include an output device, such as a display 216. In the illustrated example, the display 216 is mounted above the rack 208, but it will be apparent that the display 216 can be disposed elsewhere on the robot 120 in other examples. The display 216 can include an integrated touch screen or other input device, in some examples, The robot 120 can also include other output devices in addition to or instead of the display 216. For example, the robot 120 can include one or more speakers, light emitters such as strips of light-emitting diodes (LEDs) along the rack 208, and the like.

The chassis 200 of the robot 120 also supports various other components, including a processor 220, e.g., one or more central processing units (CPUs), graphics processing units (GPUs), or dedicated hardware controllers such as application specific integrated circuits (ASICs). The processor 220 is communicatively coupled with a non-transitory computer readable medium such as a memory 224, e.g., a suitable combination of volatile and non-volatile memory elements. The processor 220 is also coupled with a communications interface 228, such as a wireless transceiver enabling the robot 120 to communicate with other computing devices, such as the server 128 and other robots 120.

The memory 224 stores various data used for autonomous or semi-autonomous navigation, including an application 232 executable by the processor 220 to implement navigational and other task execution functions. In some examples, the above functions can be implemented via multiple distinct applications stored in the memory 224. Through execution of the application 232, the processor 220 can generate a wide variety of operational data as noted above, and store the operational data in the memory 224. The memory 224 can also store an operational data handling application 236, execution of which can configure the processor 220 to select portions of the operational data for transmission to the server 128 and/or other mobile robots 120, for deletion, and the like. The functions implemented by the processor 220 via execution of the application 236 are discussed in greater detail further below.

The chassis 200 can also support a sensor 240, such as one or more cameras and/or depth sensors (e.g., lidars, depth cameras, time-of-flight cameras, or the like) coupled with the processor 220. The sensor(s) 240 are configured to capture image and/or depth data depicting at least a portion of the physical environment of the robot 120. Data captured by the sensor(s) 240 can by used by the processor 220 for navigational purposes, e.g., path planning, obstacle avoidance, and the like.

The sensors 240 have respective fields of view (FOVs). For example, a first FOV 242a corresponds to a laser scanner, such as a lidar sensor disposed on a forward-facing surface of the chassis 200. The FOV 242a can be substantially two-dimensional, e.g., extending forwards in a substantially horizontal plane. A second FOV 242b corresponds to a camera (e.g., a depth camera, a color camera, or the like) also mounted on the forward-facing surface of the chassis 200. As will be apparent, a wide variety of other optical sensors can be disposed on the chassis 200 and/or the rack 208, with respective FOVs 242.

The components of the robot 120 that consume electrical power can be supplied with such power from a battery 244, e.g., implemented as one or more rechargeable batteries housed in the chassis 200 and rechargeable via a charging port (not shown) or other suitable charging interface.

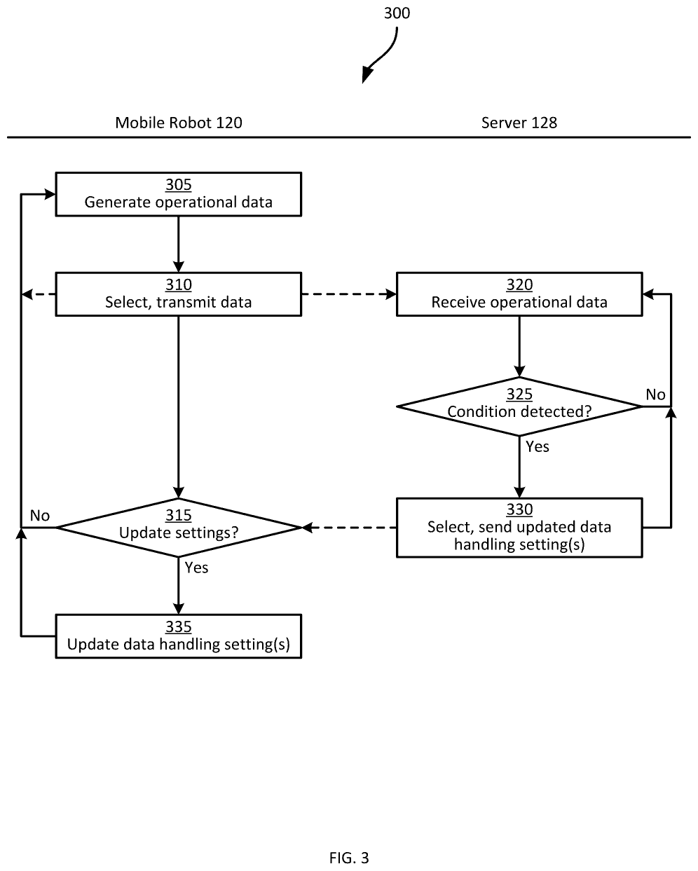

Turning to FIG. 3, a method 300 of dynamically controlled operational data handling is illustrated. The method 300 is described below in conjunction with its example performance in the facility 100. In particular, as indicated in FIG. 3, certain blocks of the method 300 are performed by the mobile robot 120, e.g., via execution of the applications 232 and 236 by the processor 220, while blocks of the method 300 are performed by the server 128, e.g., via execution of the application 144 by the processor 132.

At block 305, the mobile robot 120 is configured to generate operational data, e.g., during the execution of tasks assigned to the robot 120 by the server 128. The generation of operational data at block 305 can include capturing sensor data via the sensors 240, and processing the sensor data according to various navigational routines executed by the processor 220. By way of example, the application 232 can include an implementation of the Robot Operating System (ROS), and can thus include various executable processes for capturing sensor data, detecting obstacles from the sensor data, planning navigational paths based on the detected obstacles, and controlling the locomotive assembly 204 to travel those paths.

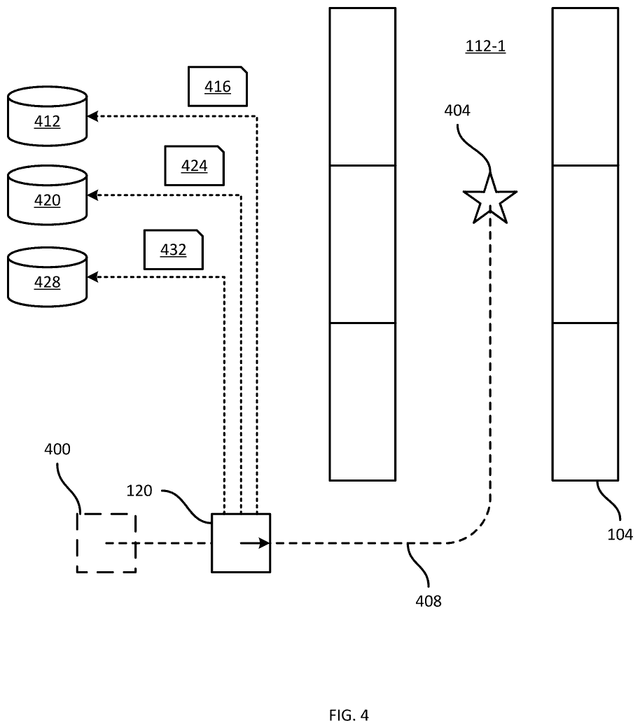

The executable processes mentioned above (e.g., referred to as nodes in the context of a ROS implementation) can each generate messages containing output data derived from the captured sensor data or other inputs. The messages can be assigned various topics, and nodes can subscribe to a subset of available topics, in order to consume certain messages to generate further output. The operational data generated at block 305 can therefore include the above-mentioned messages, which can contain a wide variety of data. For example, turning to FIG. 4, the robot 120 is shown along with a portion of the aisle 112-1. The robot 120, having received a task from the server 128 to travel from an initial location 400 to a target location 404, generated a path 408 and has begun travelling along the path 408 (i.e., executing the path 408). During generation and execution of the path 408, the processor 220 can generate various types of operational data (e.g., corresponding to the topics mentioned above, and/or specific categories of message within a given topic) and store the operational data in the memory 224.

In the example shown in FIG. 4, the processor 220 can generate and store, in a first repository 412, sensor data 416 captured via the sensors 240 (whether raw sensor data or processed sensor data, e.g., by subsampling). The first repository 412 can also include indications of detected obstacles in the sensor data, such as obstacle locations and classes (e.g., whether a detected obstacle is a worker 148, a forklift 152, or the like). The sensor data 416 can also include a subset of sensor data corresponding to the local environment of the robot 120, e.g., used to facilitate robots 120 to pass or “leapfrog” each other along an aisle 112. For example, the subset of leapfrog data can be transmitted to another robot 120 to enable that robot 120 to generate a path around the transmitting robot 120.

The processor 220 can further generate and store, in a second repository 420, various status data 424, which can include or be derived from sensor data. Examples of status data include measured velocities for the robot 120, tracked poses in the coordinate system 124 for the robot 120, a charge level of the battery 244, measured network attributes (e.g., received signal strength indicators), and the like. The status data 424 can also include, in some examples, troubleshooting-related data such as error codes, debugging flags, activity logs, and the like, usable by an operator (e.g., a remotely located operator) to diagnose issues at the robot 120.

The processor 220 can also generate and store, in a third repository 428, event data 432, which can be derived from sensor data and/or the status data in the repository 420. The event data 432 can defined any of a variety of events detected at the processor 220, including mislocalization events (e.g., when a confidence level associated with the current pose of the robot 120 is below a threshold), emergency stop events (e.g., when the robot 120 ceases movement along the path 408 in response to detecting an imminent collision), networking events (e.g., loss or establishment of connections to the WLAN in the facility 100) and the like. A wide variety of other events can also be represented in the repository 420, including detections of specific obstacle types such as forklifts that may present safety hazards to the robot 120. Other safety-related events logged in the repository 428 can include a detection of an obstacle blocking a fire exit or other point of egress from the facility 100.

The repositories 412, 420, and 428 can be implemented in the memory 224 in various forms. For example, some repositories can be implemented as serialized files containing sequences of messages or other output data generated via execution of the application 232 (e.g., bag files, in embodiments where the robot 120 implements ROS). Other repositories can include databases with a plurality of records including name-value pairs, or the like.

Although three example repositories are shown in FIG. 4, in other embodiments the processor 220 can store operational data in a wide variety of repositories with any suitable data structures, e.g., based on the type of operational data, specific content of a given element of operational data, and the like. It will be understood that generation and storage of operational data are ongoing activities, e.g., as the robot 120 travels along the path 408.

Returning to FIG. 3, at block 310 the processor 220 is configured to select and transmit a portion of the operational data from block 305. Selection and transmission of data from the repositories 412, 420, and 428 is based on data handling settings stored in the memory 224 (e.g., as a component of the application 236, or in a configuration data file associated with the application 236). The data handling settings can define, for example, how long operational data of various types is maintained in the memory 224 before being discarded. The data handling settings can also define, e.g., for each type of operational data (e.g., for each of the repositories 412, 420, and 428), a priority level used in selecting operational data at block 310. The data handling settings can further define an available data rate (which may also be referred to as bandwidth), e.g., as a volume of data per unit time at which the data selected at block 310 can be transmitted.

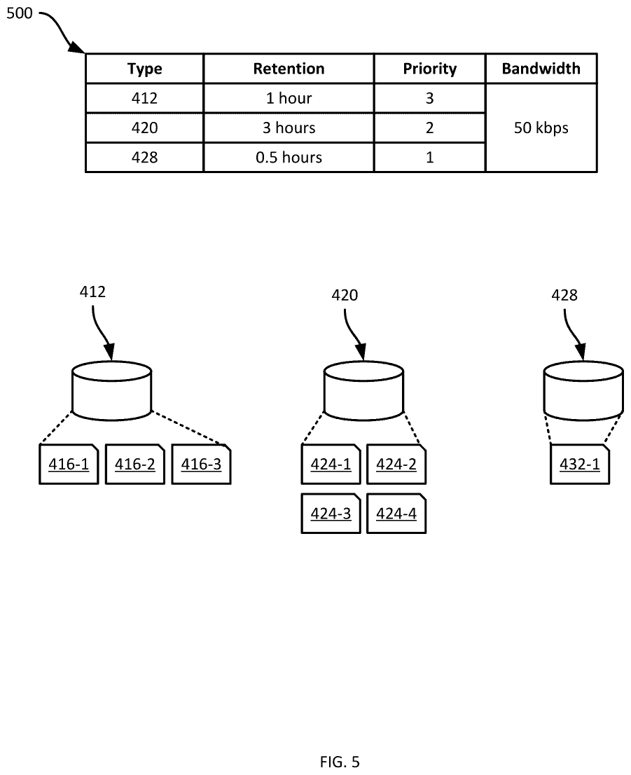

Turning to FIG. 5, an example set of data handling settings 500 is shown as maintained in the memory 224. The settings 500 include, in the illustrated example, retention time periods for data in each of the repositories 412, 420, and 428, as well as priority levels (e.g., with larger values indicating lower priority) for each repository. In addition, the settings 500 include a combined maximum bandwidth permitted to be used while transmitting data selected at block 310. In other examples, bandwidth limits can be applied to each of the repositories 412, 420, and 428. The priority levels shown in FIG. 5 need not correspond to the repositories 412, 420, and 428 as a whole in some examples. In some examples, the settings 500 can include distinct priority levels for categories of data within one or more of the repositories 412, 420, and 428. For example, the previously mentioned leapfrog data in the repository 412 can be assigned a different (e.g., higher) priority level than other sensor data 416.

In further examples, certain categories of status data 424 can be assigned higher priority levels than other categories of status data 424. For example, the settings 500 can include distinct priority levels for each of a current localization of the robot 120, the troubleshooting data mentioned above, and the like. Still further, certain categories of event data 432 in the repository 428 can be assigned different priority levels. For example, safety-related events such as the detection of a forklift, obstruction of a safety exit, or the like, can have an elevated priority level in comparison to other events in the repository 428. In further examples, navigational errors such as mislocalization events may be assigned a different priority than other events, such as low-battery events or the like.

Example contents of the repositories 412, 420, and 428 are also illustrated in FIG. 5. For example, the repository 412 contains three elements of sensor data 416-1, 416-2, and 416-3, the repository 420 contains four elements of status data 424-1, 424-2, 424-3, and 424-4, and the repository 428 contains one element 432-1 of event data. Each element of data (e.g., a file, a message, a name-value pair, or the like) can include a timestamp indicating the time that element was generated. The processor 220 can be configured to discard any elements with ages (e.g., differences between a current time and the generation time) exceeding the retention time specified in the settings 500 for the corresponding repository.

At block 310, the processor 220 can be configured to select a repository having the highest priority level. The processor 220 can therefore be configured to select the repository 428, and to retrieve the element 432-1 from the repository 428 for transmission. The element 432-1 can be deleted following retrieval and transmission. When a repository 428 contains more than one element, the processor 220 can be configured to retrieve the oldest element in that repository at block 310.

Having selected operational data for transmission, the processor 220 is configured to transmit the data, e.g., to the server 128. The processor 220 can be configured to transmit the data at the maximum allowable bandwidth, as defined in the settings 500. In some examples, the operational data can be transmitted to other robots 120 instead of, or in addition to, the server 128. The data handling settings 500 can specify, in some examples, one or more destinations for operational data selected at block 310.

Following transmission of the operational data at block 310, the processor 220 can determine, at block 315, whether to update the data handling settings 500. As discussed below, the determination at block 315 can be based on at least one of a local evaluation of the operational data at the robot 120, and evaluation of the operational data at the server 128. The processor 220 can also continue to perform blocks 305 and 310, e.g., in parallel with block 315. That is, operational data may be generated substantially continuously, and the processor 220 can be configured to perform block 310 periodically (e.g., once per second, or at any other suitable frequency). In the event that data selected at a prior performance of block 310 has not completed transmission when the next performance of block 310 occurs, the transmission may continue if the same data element is selected, or may be overridden (e.g., paused or interrupted) if a different data element is selected.

At block 320, the server 128 is configured to receive the operational data transmitted by the robot 120 at block 310. The server 128 can also receive operational data transmitted by other robots 120 at the facility 100, those robots 120 have collected and transmitted the operational data via respective performances of blocks 305 and 310.

The server 128 can be configured to store the operational data received at block 320, and can also derive additional data from the received operational data. The data generated by the server 120 can include aggregated metrics such as an average speed of a given robot 120 over a predetermined time period, derived from a plurality of velocity measurements transmitted by that robot 120. A wide variety of other metrics can also be generated at the server 128 based on operational data from one or more robots 120, including rates of various events (e.g., a rate of mislocalization events among a fleet of robots in the facility 100, an increase to which may indicate an outdated map of the facility 100).

The server 128 can also be configured to instruct one or more robots 120 to update the data handling settings 500, by detecting, at block 325, whether the operational data received at block 320 or data derived therefrom by the server 128 satisfies any predetermined conditions. The server 128 can, for example, store a plurality of criteria defining one or more conditions, and compare the operational data from block 320 to the criteria to determine whether the operational data satisfies any of the conditions. When the determination at block 325 is negative, the server 128 can continue receiving operational data block 320. When the determination at block 325 is affirmative, the server 128 proceeds to block 330.

In general, the criteria applied by the server 128 at block 325 are selected to provide either or both of faster transmission of certain data to the server 128, and increased likelihood of the server 128 receiving certain data (e.g., before that data is discarded from the relevant robot 120). The criteria, in other words, may increase the likelihood of certain data being selected for transmission at a mobile robot 120, while reducing or avoiding delays to other data that previously had a high priority (e.g., the event data in the repository 428).

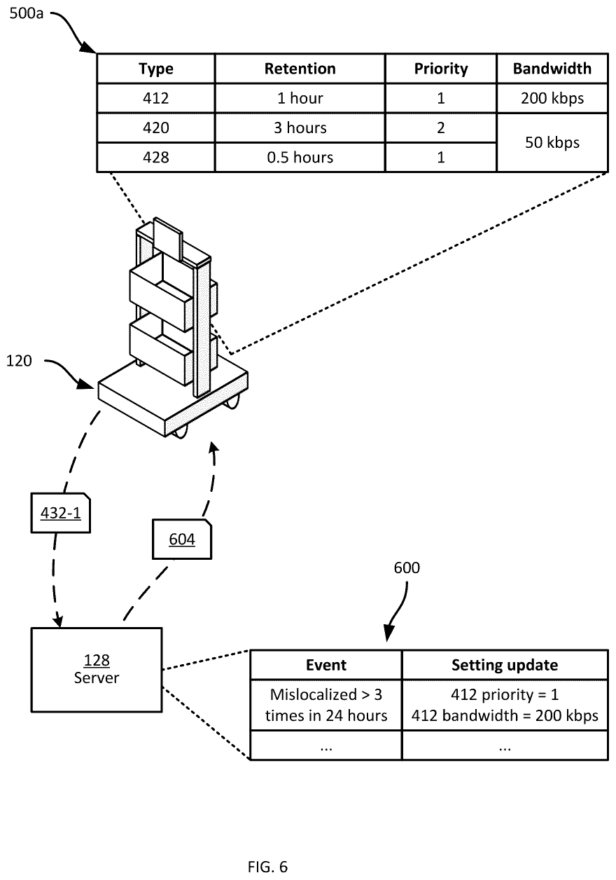

Turning to FIG. 6, an example set of criteria 600 are illustrated at the server 128. Each criterion, or group of criteria, can be associated with updated data handling settings, to be provided to the robot 120 when the criteria are satisfied. In the illustrated example, the criteria 600 include a record specifying that when more than three mislocalization events are received from the robot 120 in a twenty-four hour period, certain data handling setting updates are to be provided to that robot 120. Thus, if the data element 432-1 contains a mislocalization event, and at least two mislocalization events were received from the robot 120 in the previous day, the determination at block 325 is affirmative, and at block 330 the server 128 sends updated data handling settings 604 to the robot 120. The updated settings 604 include, in this example, an increased priority level for data in the repository 412 (e.g., sensor data in this example), and an increased bandwidth limit for data in the repository 412.

A wide variety of other criteria can also be employed at block 325. For example, the server 128 can be configured to elevate the priority level of certain sensor data (e.g., point cloud data) when a current pose of the mobile robot is within a certain region of the facility 100. For example, the region may be a portion of the facility 100 for which sensor data has not been received at the server for a threshold time period. Elevating the priority of sensor data for such regions may increase the likelihood of the server 128 receiving data with which to update a map of the facility 100.

At block 315, the determination at the robot 120 is affirmative in response to receiving the updated settings 604, and thus at block 335 the robot 120 is configured to update the data handling settings 500. Referring again to FIG. 6, updated settings 500a are illustrated, in which the priority level associated with the sensor data in the repository 412 has been increased from “3” to “1”, and a type-specific bandwidth limit of 200 kilobits per second has been added to the settings 500a. The criteria 600 can be selected, for example, to increase the likelihood that the server 128 will receive sensor data from the robot 120, e.g., for use in diagnosing possible issues with the robot 120 and/or a map of the facility 100 used by the robot 120 to navigate.

A wide variety of other criteria and corresponding setting updates can be employed by the server 128, in addition to or instead of the example shown in FIG. 6. For example, the criteria 600 can indicate that between certain times of day, available bandwidth at each robot 120 in the facility 100 is increased, e.g., to 100 kbps. In other examples, the criteria 600 can indicate that if the rate of a particular error (e.g., a mislocalization error) over time exceeds a first threshold, a retention time (e.g., for the repository 412) can be increased, and that if the rate of that error exceeds a second, higher threshold, the priority level for the repository 412 can be increased.

The updated settings 604 can include a timeframe during which the updated settings are to be applied. Following expiry of that timeframe, the settings 500a may be reverted to the settings 500. In other examples, the server 128 can instead include criteria and settings updates that effect the reversal to the settings 500, such as a record indicating that when no mislocalization errors have been detected in the past day, the priority level for the repository 412 is to be set to “3”, and any type-specific bandwidth limit for the repository 412 is to be discarded.

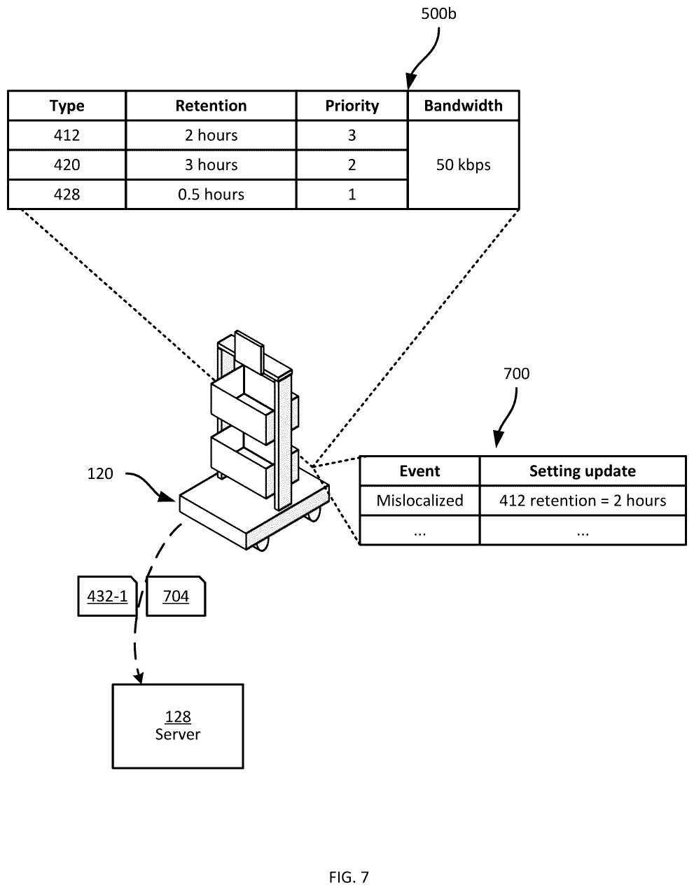

The robot 120 can also make an affirmative determination at block 315 based on locally stored criteria. For example, referring to FIG. 7, the memory 224 can store criteria 700 indicating, for example, that in response to detection of a mislocalization event, the retention period for the repository 412 is updated to two hours from one hour. Thus, in response to generation of the element 432-1, for example, the robot 120 can update the settings 500 to settings 500b, with the extended retention period mentioned above. The robot 120 can also transmit the element 432-1 to the server 128 along with a message 704 indicating the locally-effected handling settings change.

In other embodiments, rather than via the evaluation of static criteria as discussed above, the server 128 and/or the robot 120 can be configured to implement a classifier, such as a deep learning algorithm (e.g., a convolutional neural network or the like, with an embedding stage applied to the operational data received at block 320) trained using received operational data and manually-generated handling settings updates.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
maintaining data handling settings at a mobile robot;
generating operational data at the mobile robot, the operational data defining a current state of the mobile robot;
storing the operational data in a memory of the mobile robot;
selecting, based on the data handling settings, a portion of the operational data;
transmitting the selected portion of the operational data;
in response to a determination that the operational data meets a condition, obtaining updated data handling settings; and
selecting a subsequent portion of the operational data for transmission according to the updated data handling settings.

2. The method of claim 1, further comprising transmitting the selected portion to a server or another mobile robot.

3. The method of claim 1, wherein the operational data includes at least one of sensor data, navigational events, or robot status data.

4. The method of claim 1, wherein the data handling settings include a priority level for each of a plurality of types of the operational data.

5. The method of claim 4, wherein the data handling settings further include a retention time period for each of the types; and
wherein storing the operational data includes discarding a portion of the operational data having an age greater than the retention period.

6. The method of claim 5, wherein the updated data handling settings include an extended retention period.

7. The method of claim 1, further comprising:
determining, at the mobile robot, that the operational data meets the condition; and
retrieving the updated data handling settings from a memory of the mobile robot.

8. The method of claim 7, further comprising: transmitting a message to a server including the updated data handling settings.

9. The method of claim 1, further comprising:
receiving, from a server, the updated data handling settings in response to the determination, at the server, that the operational data meets a condition.

10. A computing device, comprising:
a memory storing data handling settings; and
a processor configured to:
generate operational data defining a current state of a mobile robot;
store the operational data in the memory;
select, based on the data handling settings, a portion of the operational data;
transmit the selected portion of the operational data;
in response to a determination that the operational data meets a condition, obtain updated data handling settings; and
select a subsequent portion of the operational data for transmission according to the updated data handling settings.

11. The computing device of claim 10, wherein the processor is further configured to transmit the selected portion to a server or another mobile robot.

12. The computing device of claim 10, wherein the operational data includes at least one of sensor data, navigational events, or robot status data.

13. The computing device of claim 10, wherein the data handling settings include a priority level for each of a plurality of types of the operational data.

14. The computing device of claim 13, wherein the data handling settings further include a retention time period for each of the types; and
wherein the processor is configured to store the operational data by discarding a portion of the operational data having an age greater than the retention period.

15. The computing device of claim 14, wherein the updated data handling settings include an extended retention period.

16. The computing device of claim 10, wherein the processor is further configured to:
determine that the operational data meets the condition; and
retrieve the updated data handling settings from the memory.

17. The computing device of claim 16, wherein the processor is further configured to:
transmit a message to a server including the updated data handling settings.

18. The computing device of claim 10, wherein the processor is further configured to:
receive, from a server, the updated data handling settings in response to the determination, at the server, that the operational data meets a condition.
